(19) United States
(12) Patent Application Publication
(10) Pub. No.: US 2010/0070685 A1
(43) Pub. Date: Mar. 18, 2010

(54) METHOD FOR OPERATING MEMORY CARD

(75) Inventors: Hsiu-Hsien CHU, TAIPEI CITY (TW); Pei-Tai CHEN, TAIPEI CITY (TW)

Correspondence Address: BRIAN M. MCINNIS, 12th Floor, Ruttonjee House, 11 Duddell Street, Hong Kong, HK

(73) Assignee: INCOMM TECHNOLOGIES CO., LTD., TAIPEI CITY (TW)

(21) Appl. No.: 12/345,680

(22) Filed: Dec. 30, 2008

(30) Foreign Application Priority Data
Sep. 17, 2008 (TW) 97135679

(51) Int. Cl. G06F 12/02; G06F 12/00

(52) U.S. Cl. 711/103; 711/115; 711/170; 711/E12.001; 711/E12.008; 711/E12.002; 707/E17.01

(57) ABSTRACT

A method is used for operating a memory card, which comprises following steps: (1) a file is preloaded in the first sector of the file allocation table and the second sectors of the description block, wherein the file at least including first data, second data and third data, wherein the first sector is filled up with the first data, only one of the second sectors is not filled up with the second data and the other second sectors are filled up with the third data. (2) A command is received, where the command is capable of updating the file. (3) The command for the first sector is ignored. (4) The only one of the second sectors is updated according to the command. (5) The command for the other second sectors is ignored. (6) The second data of the only one of the second sectors are recovered.

### RELATED APPLICATIONS

This application claims priority to Taiwan Application Serial Number 97135679, filed Sep. 17, 2008, which is herein incorporated by reference.

### BACKGROUND

1. Field of Invention

The present invention relates to a method for operating a memory device. More particularly, the present invention relates to a method for operating a memory card.

2. Description of Related Art

A memory card or flash memory card is a solid-state electronic flash memory data storage device used with digital cameras, handheld and Mobile computers, telephones, music players, video game consoles, and other electronics. They offer high re-record-ability, power-free storage, small form factor, and rugged environmental specifications. There are also non-solid-state memory cards that do not use flash memory, and there are different types of flash memory.

The memory card includes a controller and a flash memory, where the flash memory includes a lot of memory cells. In practice, a plurality of procedure files, such as above-mentioned command file and response files, are preloaded in the memory card. The controller can control the memory card to execute specific functions by means of these procedure files.

However, the user may operate the memory card with a careless mistake, which results in that the procedure files may be deleted or modified. For the foregoing reasons, there is a need for a new method for operating a memory card to prevent that procedure files are modified or deleted. The present disclosure meets this need.

### SUMMARY

It is therefore an objective of the present invention to provide a method for operating a memory card including a file allocation table having at least one first sector and a description block having a plurality of second sectors.

In accordance with an embodiment of the present disclosure, the method comprise following step:

(1) A file is preloaded in the first sector of the file allocation table and the second sectors of the description block, wherein the file at least including first data, second data and third data, wherein the first sector is filled up with the first data, only one of the second sectors is not filled up with the second data and the other second sectors are filled up with the third data.

(2) A command is received, where the command is capable of updating the file.

(3) The command for the first sector is ignored.

(4) The only one of the second sectors is updated according to the command.

(5) The command for the other second sectors is ignored.

(6) The second data of the only one of the second sectors are recovered.

It is to be understood that both the foregoing general description and the following detailed description are by examples, and are intended to provide further explanation of the invention as claimed.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a flow chart of a method 100 according to an embodiment of the present disclosure; and

FIG. 2 is a flow chart of step 160 of the method 100.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

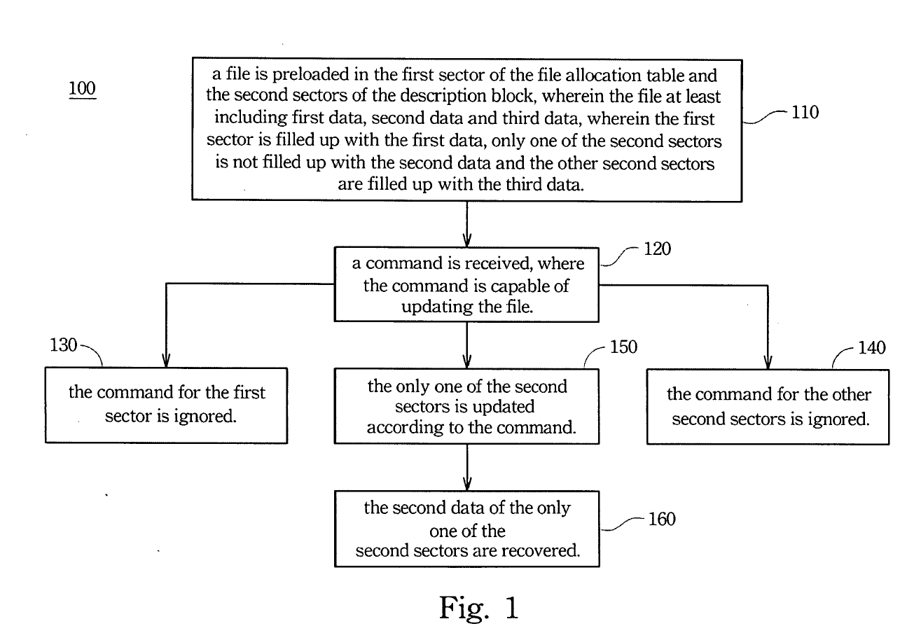

Please refer to FIG. 1. FIG. 1 is a flow chart of a method 100 in accordance with an embodiment of the present disclosure. In the method 100, it should be noted that one step might be performed in series, in parallel, in combination, or otherwise in conjunction with another if the specific order is not described or inferred in the embodiment. The method 100 is used for operating a memory card including a file allocation table having at least one first sector and a description block having a plurality of second sectors. In FIG. 1, the method 100 comprises steps 110-160:

(1) Step 110: a file is preloaded in the first sector of the file allocation table and the second sectors of the description block, wherein the file at least including first data, second data and third data, wherein the first sector is filled up with the first data, only one of the second sectors is not filled up with the second data and the other second sectors are filled up with the third data.

(2) Step 120: a command is received, where the command is capable of updating the file.

(3) Step 130: the command for the first sector is ignored.

(4) Step 140: the command for the other second sectors is ignored.

(5) Step 150: the only one of the second sectors is updated according to the command.

(6) Step 160: the second data of the only one of the second sectors are recovered.

Therefore, the file in the memory card is protected by the method 100, so that the file can't be modified or deleted. Besides, the file that is not protected may be read, wrote, searched, modified or deleted.

In practice, the capacity of the above-mentioned first sector of the file allocation table is 512 bytes. Additionally, the capacity of each the second sectors of the description block is 512 bytes.

Generally, the speed of ignoring the command is faster than the speed of data recovering. Thus, the first data of the file filled with the first sector of the file allocation table in step 110. Then, the command for the first sector is ignored in step 130.

However, the first data of the file filled with the first sector of the file allocation table in step 110, which signifies that only one second sector of the second sectors is not filled up with the second data of the file and the other second sectors are filled up with the third data of the file. In other words, the only one sector may include the second data of the file. Besides, the particular sector may further include other data. Thus, the second data of the only one of second sectors are recovered by means of data recovering in step 160.

Moreover, only one particular sector of the second sectors is not filled up with the second data of the file and the other second sectors are filled up with the third data of the file in step 110. Thus, the command for the other second sectors are ignored in step 150.

Accordingly, the second data of the only second sector are recovered and the command for the other second sectors and the first sector are ignored when the memory card receives the command. Thus, the method 100 with high executing speed is capable of protecting the file that can't be modified or deleted.

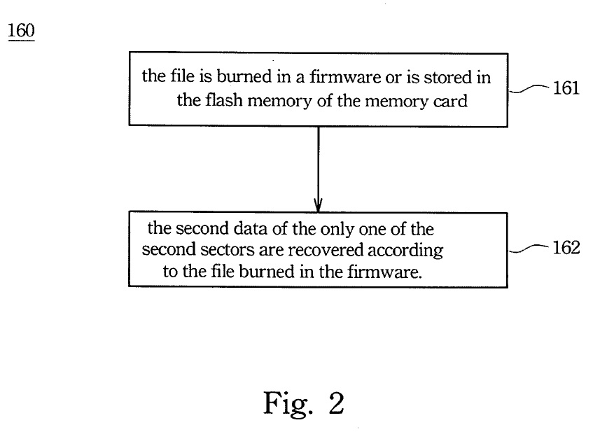

For a more complete understanding step 160 of the method 400 to execute data recovering, please refer to FIG. 2. The FIG. 2 is a flow chart of step 160 of the method 100. In the step 160, it should be noted that one sub-step might be performed in series, in parallel, in combination, or otherwise in conjunction with another if the specific order is not described or inferred in the embodiment. In FIG. 2 the step 160 comprises sub-steps 161-162:
(1) Sub-step 161: the file is burned in a firmware or is stored in the flash memory of the memory card.
(2) Sub-step 162: the second data of the only one of the second sectors are recovered according to the file burned in the firmware.

Accordingly, the file could be recovered in step 160.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating a memory card including a file allocation table having at least one first sector and a description block having a plurality of second sectors, which comprising:
preloading a file in the first sector of the file allocation table and the second sectors of the description block, wherein the file at least including a first data, a second data and a third data, wherein the first sector is filled up with the first data, only one of the second sectors is not filled up with the second data and the other second sectors are filled up with the third data;
receiving a command, wherein the command is capable of updating the file;
ignoring the command for the first sector;
updating the only one of the second sectors according to the command;
ignoring the command for the other second sectors; and
recovering the second data of the only one of the second sectors.

2. The method as claimed in claim 1, wherein the capacity of the first sector is 512 bytes.

3. The method as claimed in claim 1, wherein the capacity of the second sector is 512 bytes.

4. The method as claimed in claim 1, wherein preloading the file in the file allocation table and the description block, comprising:
burning the file in a firmware of the memory card.

5. The method as claimed in claim 4, wherein recovering the second data of the only one of the second sectors, comprising:
recovering the second data of the only one of the second sectors according to the file burned in the firmware.
